(19) United States
(12) Patent Application Publication
(10) Pub. No.: US 2013/0146198 A1
(43) Pub. Date: Jun. 13, 2013

(54) COMPOSITE WIRE REINFORCEMENT FOR A TIRE, COATED WITH RUBBER HAVING ENHANCED WATER-BARRIER PROPERTIES

(71) Applicants: Yoonhee Chang, Saitama (JP); Salvatore Pagano, Chiyoda-ku (JP)

(72) Inventors: Yoonhee Chang, Saitama (JP); Salvatore Pagano, Chiyoda-ku (JP)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/700,012

(22) PCT Filed: May 17, 2011
(86) PCT No.: PCT/EP11/57921

§ 371 Date: Feb. 26, 2013

(30) Foreign Application Priority Data
May 27, 2010 (FR) 1054094

(51) Int. Cl. B60C 1/00; D07B 1/16

(52) U.S. Cl. 152/526; 57/258; 152/540; 152/552

(57) ABSTRACT

A composite wire or thread-based reinforcement is coated with rubber and may be used for reinforcing a finished rubber article, such as a tyre. The reinforcement includes one or more textile or metallic reinforcing wires or threads, and a coating rubber that coats each wire or thread. The coating rubber is formed of a rubber composition that includes at least one diene elastomer, a reinforcing filler, between 10 and 150 phr (parts by weight per hundred parts of elastomer or rubber) of a platy filler, and a crosslinking system. The coating rubber has improved water-barrier properties, thus giving the composite wire or thread-based reinforcement better protection against corrosion or ageing due to penetration of water, for example through tyre tread.

### 1. FIELD OF THE INVENTION

The field of the present invention is that of metallic or textile reinforcing elements or “reinforcements”, coated or clad with rubber, which may be used notably for reinforcing finished articles or semi-finished products made of rubber, for instance motor vehicle tyres.

The invention also relates to the rubber compositions used in tyres, in particular in the crown of tyres with radial carcass reinforcement, and also to the protection of the crown reinforcements, also known as the belts, of these tyres.

### 2. PRIOR ART

A tyre with radial carcass reinforcement comprises, in a known manner, a tread, two inextensible beads, two sidewalls joining the beads to the tread and a belt placed circumferentially between the carcass reinforcement and the tread, this belt being composed of various plies (or “layers”) of rubber which may or may not be reinforced with reinforcing elements or reinforcements such as cords or monofilaments, of the metallic or textile type.

More specifically, a tyre belt generally consists of at least two superposed belt plies, sometimes referred to as “working” plies or “crossed” plies, the reinforcements of which are placed so as to be practically parallel to one another within a ply, but crossed from one ply to the other, that is to say inclined, whether symmetrically or not, relative to the median circumferential plane, by an angle which is generally between 10° and 45° depending on the type of tyre in question. Each of these two crossed plies consists of a rubber matrix or “calendering rubber” that coats the reinforcements. In the belt, the crossed plies may be finished off by various other auxiliary rubber plies or layers, having widths that vary depending on the case, and which may or may not contain reinforcements; mention will be made by way of example of simple rubber cushions, of plies known as “protective” plies, the role of which is to protect the rest of the belt from external attack, perforations, or else plies known as “hooping” plies comprising reinforcements oriented substantially along the circumferential direction (plies known as “zero-degree” plies), irrespective of whether they are radially outer or inner to the crossed plies.

For the reinforcement of the above belts, in particular of their crossed plies, protective plies or hooping plies, use is generally made of reinforcements in the form of steel cords or textile cords consisting of thin threads assembled together by cabling or twisting.

To effectively fulfil their role of reinforcing the belts of radial tyres, subjected, as is known, to very high stresses when the tyres are running, these steel or textile cords must satisfy a very large number of, sometimes contradictory, technical criteria such as a high compression endurance, a high tensile strength, a high wear resistance and a high corrosion resistance, a strong adhesion to the surrounding rubber, and must be capable of maintaining these properties at a very high level for as long a time as possible.

However, it is known that corrosive agents such as water, capable of penetrating into the tyres, especially following cuts or other attacks on their crown, may travel to the belt. The presence of moisture in the belt, moreover under relatively high temperature conditions, risks causing corrosion and accelerating fatigue processes (phenomena known as “corrosion fatigue”), while being detrimental to the adhesion between the steel cords and the neighbouring rubber composition, finally playing a major role in the longevity of the tyre performances. This is likewise the case for the textile cords, for which the presence of moisture runs the risk of being detrimental to the adhesion to the rubber in the long term, and ultimately the endurance of the reinforcements.

### 3. BRIEF DESCRIPTION OF THE INVENTION

Now, the Applicants have discovered, in the course of their research, a specific rubber composition that has excellent water-barrier properties and which is thus capable of giving improved protection to the reinforcements, in particular to the belt of tyres.

Consequently, a first subject of the invention relates to a rubber-coated composite thread-based reinforcement, which may be used notably for reinforcing a finished rubber article such as a tyre, comprising one or more textile or metallic reinforcing threads, and a rubber composition named coating rubber coating each thread, this composite thread-based reinforcement being characterized in that the coating rubber comprises at least one diene elastomer, a reinforcing filler, between 10 and 150 phr of a platy filler, and a crosslinking system.

The present invention also relates to the use of the thread-based reinforcement of the invention as an element for reinforcing finished articles or semi-finished products made of rubber, particularly tyres, especially tyres intended to equip passenger motor vehicles, SUV (sport utility vehicles), two-wheeled vehicles (especially bicycles and motor cycles), aircraft, industrial vehicles chosen from vans, heavy-goods vehicles, i.e., metro, bus, road haulage engines (lorries, tractors, trailers), off-road vehicles such as agricultural or civil engineering engines, and other transportation or maintenance vehicles.

The invention also relates per se to any finished article or semi-finished product made of rubber, in particular a tyre, in either raw or crosslinked form, which comprises a thread-based reinforcement according to the invention.

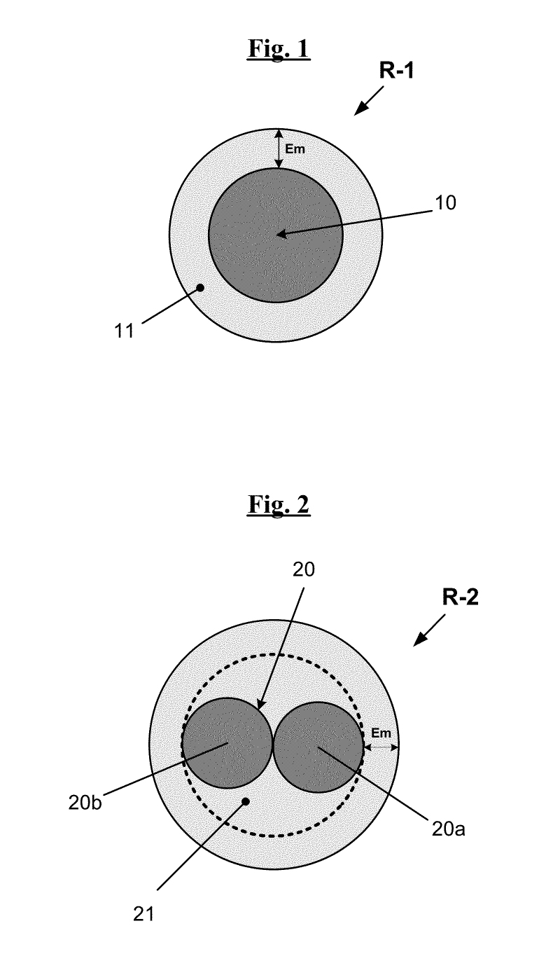

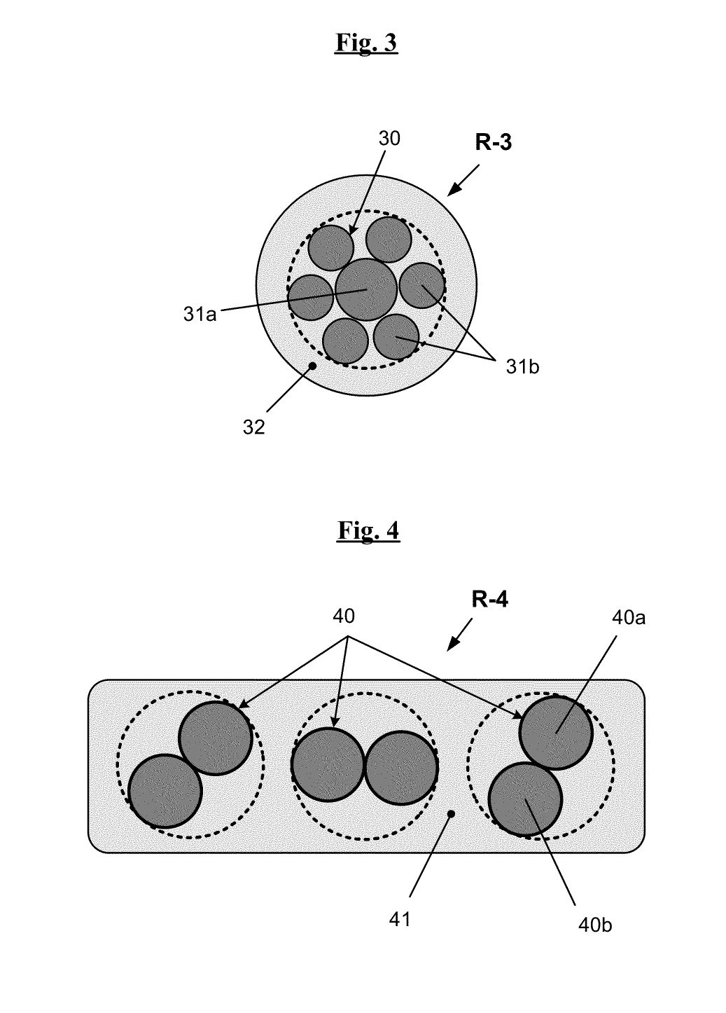

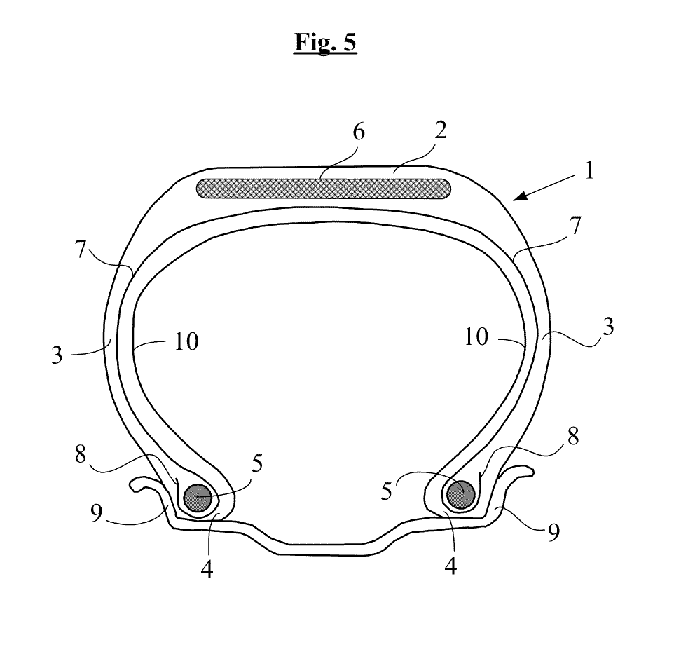

The invention and the advantages thereof will be readily understood in the light of the description and the implementation examples that follow, and also of the figures relating to these examples, which show schematically:
in cross section, an example of a thread-based reinforcement according to the invention (FIG. 1);
in cross section, another example of a thread-based reinforcement in accordance with the invention (FIG. 2);
in cross section, another example of a thread-based reinforcement in accordance with the invention (FIG. 3);
in cross section, another example of a thread-based reinforcement in accordance with the invention, in the form of a band of three cables buried in their coating rubber (FIG. 4);
in radial section, a tyre outer casing with radial carcass reinforcement in accordance with the invention, incorporating in its belt thread-based reinforcements according to the invention (FIG. 5).

### 4. DETAILED DESCRIPTION OF THE INVENTION

In the present description, unless expressly mentioned otherwise, all the percentages (%) indicated are mass percentages.

The abbreviation phr means parts by weight per hundred parts of elastomer or rubber (relative to the total of the elastomers if several elastomers are present).

Moreover, any range of values denoted by the expression “between a and b” represents the range of values extending from more than a to less than b (i.e., limits a and b excluded), whereas any range of values denoted by the expression “from a to b” means the range of values ranging from a up to b (i.e., including the strict limits a and b).

The composite reinforcement of the invention, also referred to as the “thread-based reinforcement” (i.e., reinforcing element comprising one or more threads) is thus a reinforcement coated with rubber, in raw or cured (crosslinked) form. Its essential characteristic is that it comprises at least one (i.e., one or more) textile or metallic reinforcing threads, and also a specific rubber composition known as a coating rubber, which covers and coats the said thread individually or several threads collectively. The structure of this reinforcement of the invention is described in detail hereinbelow.

### 4.1.—Reinforcing Thread

In the present application, the term reinforcing thread generally means any elongated element of great length relative to its cross section, irrespective of the shape of this cross section, for example circular, oblong, rectangular or square, or even flat, this thread possibly being rectilinear or non-rectilinear, for example twisted, or wavy. When it is of circular shape, its diameter is preferably less than 5 mm and more preferentially in a range from 0.1 to 2 mm.

This reinforcing thread may take any known form: it may be, for example, an elemental monofilament of large diameter (for example and preferably greater than or equal to 50 μm), an elementary strip, a film, a multifilament fibre (consisting of a plurality of elementary filaments of small diameter, typically less than 30 μm), a textile plied thread formed from several fibres twisted together, a textile or metallic cord formed from several fibres or monofilaments cabled or twisted together, or alternatively an assembly or row of threads comprising several of these monofilaments, fibres, plied threads or cords grouped together.

According to one preferential embodiment, the thread-based reinforcement of the invention may thus be in the form of a single reinforcing thread, clad in its coating rubber, to constitute a unitary composite thread clad with its specific rubber composition.

According to another preferential embodiment, the thread-based reinforcement of the invention may also be in the form of several reinforcing threads (monofilaments, strips, films, fibres, plied yarns or cables) grouped together, for example aligned in a main direction, which may or may not be rectilinear, these reinforcing threads then being collectively clad in their coating rubber, to constitute, for example, a strip or band, or a composite rubber fabric in various forms such as those usually encountered in the structure of tyres. As preferential examples of thread-based reinforcements in accordance with the invention, mention will be made particularly of the fabrics constituting the carcass reinforcement plies, the protective crown plies, the pooping crown plies or the working crown plies present in tyre belts, the coating rubber constituting the calendering rubber of these fabrics when they are manufactured by calendering.

According to one preferential embodiment, the reinforcing thread is a metallic reinforcing thread, especially made of carbon steel as usually used in steel cords for tyres; however, it is, of course, possible to use other steels, for example stainless steels. When a carbon steel is used, its carbon content is preferably between 0.4% and 1.2% and especially between 0.5% and 1.1%. The invention applies in particular to any steel of the steel cord type, known as normal tensile (NT) steel, high tensile (HT) steel, super high tensile (SHT) steel or ultra high tensile (UHT) steel. The steel may be coated with an adhesive layer such as brass or zinc.

According to another preferential embodiment, the reinforcing thread is a textile thread, consisting of a synthetic or natural polymer material, or even of a mineral material. Examples that may especially be mentioned include reinforcing threads made of polyvinyl alcohol (PVA), aliphatic polyamide (e.g., polyamides 4-6, 6, 6-6, 11 or 12), aromatic polyamide (or “aramid”), polyamide-imide, polyimide, polyester (e.g., PET, PEN), aromatic polyester, polyethylene, polypropylene, polyketone, cellulose, rayon, viscose, polyphenylene benzobisoxazole (PBO), glass, carbon or ceramic.

### 4.2—Coating Rubber

The specific coating rubber used is a rubber composition comprising at least one diene elastomer, a reinforcing filler, between 10 and 150 phr of a platy filler, and a crosslinking system.

### A) Diene Elastomer

The term elastomer (or rubber, the two terms being synonymous) of the “diene” type recalls that what should be understood is an elastomer at least partly derived (i.e., a homopolymer or a copolymer) from diene monomers (monomers bearing two conjugated or non-conjugated carbon-carbon double bonds).

Diene elastomers may be classified in a known manner into two categories: those said to be “essentially unsaturated” and those said to be “essentially saturated”. Butyl rubbers, for instance copolymers of dienes and of α-olefins of EPDM type, fall into the category of essentially saturated diene elastomers, having a content of units of diene origin that is low or very low, always less than 15% (mol %). In contrast, the term “essentially unsaturated diene elastomer” means a diene elastomer at least partly derived from conjugated diene monomers, with a content of units of diene origin (conjugated dienes) that is greater than 15% (mol %). In the category of “essentially unsaturated” diene elastomers, the term “highly unsaturated” diene elastomer means a diene elastomer with a content of units of diene origin (conjugated dienes) that is greater than 50%.

It is preferred to use at least one diene elastomer of the highly unsaturated type, in particular a diene elastomer chosen from the group consisting of natural rubber (NR), synthetic polyisoprenes (IR), polybutadienes (BR), butadiene copolymers, isoprene copolymers and blends of these elastomers. Such copolymers are more preferentially chosen from the group consisting of butadiene-styrene copolymers (SBR), isoprene-butadiene copolymers (BIR), isoprene-styrene copolymers (SIR) and isoprene-butadiene-styrene copolymers (SBIR), and blends of such copolymers.

The elastomers may be, for example, block, statistical, sequenced or microsequenced elastomers, and may be prepared in dispersion or in solution; they may be coupled and/or in star form or alternatively functionalized with a coupling and/or starring or functionalizing agent. For coupling with carbon black, mention may be made, for example, of functional groups comprising a C—Sn bond or amino functional groups such as benzophenone, for example; for coupling with a reinforcing inorganic filler such as silica, mention may be made, for example, of silanol or polysiloxane functional groups with a silanol end (as described, for example, in U.S. Pat. No. 6,013,718), alkoxysilane groups (as described, for example, in U.S. Pat. No. 5,977,238), carboxylic groups (as described, for example, in U.S. Pat. No. 6,815,473 or US 2006/0 089 445) or alternatively polyether groups (as described, for example, in U.S. Pat. No. 6,503,973). As examples of such functionalized elastomers, mention may also be made of elastomers (such as SBR, BR, NR or IR) of the epoxidized type.

Elastomers that are preferentially suitable for use are polybutadienes, and in particular those with a content of -1,2 units of between 4% and 80% or those with a content of cis-1,4 units of greater than 80%, polyisoprenes, butadiene-styrene copolymers and in particular those with a styrene content of between 5% and 50% by weight and more particularly between 20% and 40%, a content of -1,2 bonds in the butadiene part of between 4% and 65%, a content of trans-1,4 bonds of between 20% and 80%, butadiene-isoprene copolymers and especially those with an isoprene content of between 5% and 90% by weight and a glass transition temperature (Tg) of from −40° C. to −80° C., and isoprene-styrene copolymers and especially those with a styrene content of between 5% and 50% by weight and a Tg of between −25° C. and −50° C.

In the case of the butadiene-styrene-isoprene copolymers, the ones that are especially suitable for use are those with a styrene content of between 5% and 50% by weight and more particularly between 10% and 40%, an isoprene content of between 15% and 60% by weight and more particularly between 20% and 50%, a butadiene content of between 5% and 50% by weight and more particularly between 20% and 40%, a content of -1,2 units in the butadiene part of between 4% and 85%, a content of trans-1,4 units in the butadiene part of between 6% and 80%, a content of -1,2 plus -3,4 units in the isoprene part of between 5% and 70% and a content of trans-1,4 units in the isoprene part of between 10% and 50%, and more generally any butadiene-styrene-isoprene copolymer with a Tg of between −20° C. and −70° C.

According to one particularly preferential embodiment of the invention, the diene elastomer is chosen from the group consisting of natural rubber, synthetic polyisoprenes, polybutadienes with a content of cis-1,4 bonds of greater than 90%, and butadiene-styrene copolymers, and blends of these elastomers.

More preferentially, the rubber composition comprises 50 to 100 phr of a copolymer based on styrene and butadiene, i.e., a copolymer of at least one styrene monomer and of at least one butadiene monomer; in other words, the said copolymer based on styrene and butadiene comprises by definition at least units derived from styrene and units derived from butadiene, the said copolymer being able to be used with up to 50 phr of another diene elastomer, in particular of a polybutadiene or more preferentially of natural rubber or of a synthetic polyisoprene. Suitable butadiene monomers are especially 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene or 2-methyl-3-isopropyl-1,3-butadiene and an aryl-1,3-butadiene. Suitable styrene monomers are especially styrene, methylstyrenes, para-tert-butylstyrene, methoxystyrenes and chlorostyrenes.

Preferably, this copolymer based on styrene and butadiene is chosen from the group consisting of styrene-butadiene copolymers (abbreviated as SBR), styrene-butadiene-isoprene copolymers (abbreviated as SBIR) and blends of such copolymers.

Among the SBIR copolymers, mention may especially be made of those with a styrene content between 5% and 50% by weight and more particularly between 10% and 40%, an isoprene content between 15% and 60% by weight and more particularly between 20% and 50%, a butadiene content between 5% and 50% by weight and more particularly between 20% and 40%, a content (mol %) of -1,2 units in the butadiene part of between 4% and 85%, a content (mol %) of trans-1,4 units in the butadiene part of between 6% and 80%, a content (mol %) of -1,2 units plus -3,4 units in the isoprene part of between 5% and 70% and a content (mol %) of trans-1,4 units in the isoprene part of between 10% and 50%.

More preferably, an SBR copolymer is used. Among the SBR copolymers, mention may especially be made of those with a styrene content of between 5% and 60% by weight and more particularly of between 20% and 50%, a content (mol %) of -1,2 bonds in the butadiene part of between 4% and 75% and a content (mol %) of trans-1,4 bonds in between 10% and 80%.

Preferably, the Tg of the copolymer based on styrene and butadiene is greater than −40° C. and especially between −40° C. and 0° C.; even more preferentially, its Tg is greater than −35° C., especially between −35° C. and 0° C., in particular greater than −30° C., especially between −30° C. and 0° C. (for example in a range from −25° C. to −5° C.). According to other possible embodiments, the preferential Tg range may also include positive values (i.e., greater than 0° C.), for example within a range from −30° C. to +30° C. (in particular from −25° C. to +25° C.)

A person skilled in the art knows how to modify the microstructure of a copolymer based on styrene and butadiene, in particular of an SBR, in order to increase and adjust its Tg, especially by modifying the contents of styrene, of -1,2 bonds or else of trans-1,4 bonds in the butadiene part. Use is more preferably made of an SBR (solution or emulsion) with a styrene content (mol %) which is greater than 35%, more particularly between 35% and 60%, in particular within a range from 38% to 50%. SBRs having a relatively high Tg are well known to those skilled in the art; they have been used in particular in tyre treads for improving some of their working properties.

According to another preferential embodiment, the rubber composition comprises 50 to 100 phr of natural rubber or of synthetic polyisoprene, the said natural rubber or synthetic polyisoprene possibly being used especially as a blend with up to 50 phr of another diene elastomer, in particular of a polybutadiene or, more preferentially, of a copolymer based on styrene and butadiene as described above.

Synthetic elastomers other than diene elastomers, or even polymers other than elastomers, for example thermoplastic polymers, could also be combined, in a minority amount, with the diene elastomers of the treads according to the invention.

The Tg of the elastomers described herein is measured in a conventional manner that is well known to those skilled in the art, on an elastomer in dry form (i.e., without extender oil) and by DSC (for example according to ASTM D3418-1999).

### B) Reinforcing Filler

The composition of the invention comprises any type of reinforcing filler known for its capacities for reinforcing a rubber composition that may be used for the manufacture of tyres, for example an organic filler such as carbon black, an inorganic reinforcing filler such as silica, which is combined, in a known manner, with a coupling agent, or alternatively a mixture of these two types of filler.

Such a reinforcing filler preferentially consists of nanoparticles with a mean (by mass) size of less than one micrometre, generally less than 500 nm, usually between 20 and 200 nm, in particular, and more preferentially between 20 and 150 nm.

Preferentially, the total content of reinforcing filler (in particular of silica or carbon black or a mixture of silica and carbon black) is greater than 20 phr, in particular between 20 and 100 phr. Beyond 100 phr, there is a risk of increasing the hysteresis and thus the resistance to rolling of the tyres. For this reason, the total content of reinforcing filler is more preferentially within a range from 30 to 90 phr.

Carbon blacks that are suitable for use include any carbon black, especially the blacks conventionally used in tyres or their treads (known as tyre grade). Among the latter, mention will be made more particularly of the carbon blacks of the series 100, 200, 300, 600 or 700 (ASTM grades), for instance the blacks N115, N134, N234, N326, N330, N339, N347, N375, N550, N683 and N772. The carbon blacks may, for example, be already incorporated into the diene elastomer, especially the isoprene elastomer, in the form of a masterbatch (see, for example, application WO 97/36724 or WO 99/16600).

As examples of organic fillers other than carbon blacks, mention may be made of the functionalized polyvinyl organic fillers as described in applications WO-A-2006/069 792, WO-A-2006/069 793, WO-A-2008/003 434 and WO-A-2008/003 435.

The term “reinforcing inorganic filler” should be understood herein as meaning any inorganic or mineral filler, irrespective of its colour and its origin (natural or synthetic), also known as “white” filler or occasionally “clear” filler, as opposed to carbon black, which is capable of reinforcing by itself, without any means other than an intermediate coupling agent, a rubber composition intended for the manufacture of tyres, in other words capable of replacing, in its reinforcing function, a conventional tyre-grade carbon black; such a filler is generally characterized, in a known manner, by the presence of hydroxyl groups (—OH) on its surface.

Reinforcing inorganic fillers that are especially suitable for use include mineral fillers of the siliceous type, preferentially silica (SiO₂). The silica used may be any reinforcing silica known to those skilled in the art, especially any precipitated or fumed silica with a BET surface area and also a CTAB specific surface area both of less than 450 m²/g, preferably from 30 to 400 m²/g, and especially between and 300 m²/g. Examples of highly dispersible precipitated silicas (HDS) that will be mentioned include the silicas Ultrasil 7000 and Ultrasil 7005 from the company Degussa, the silicas Zeosil 1165 MP, 1135 MP and 1115 MP from the company Rhodia, the silica Hi-Sil EZ150G from the company PPG and the silicas Zeopol 8715, 8745 and 8755 from the company Huber.

To couple the reinforcing inorganic filler to the diene elastomer, use is made, in a known manner, of a coupling agent (or bonding agent) that is at least difunctional intended to ensure a sufficient connection, of chemical and/or physical nature, between the inorganic filler (surface of its particles) and the diene elastomer. Use is made in particular of at least difunctional organosilanes or polyorganosiloxanes.

Use is made especially of silane polysulfides, which are said to be “symmetric” or “asymmetric” according to their particular structure, as described, for example, in applications WO 03/002 648 (or US 2005/016 651) and WO 03/002 649 (or US 2005/016 650).

Silanes that are in particular suitable for use, without the definition below being limiting, include the silane polysulfides corresponding to the general formula (I) below:

Z-A-Sₓ-A-Z (I)

in which:
x is an integer from 2 to 8 (preferably from 2 to 5);
the symbols A, which may be identical or different, represent a divalent hydrocarbon-based radical (preferably a C₁-C₁₈ alkylene group or a C₆-C₁₂ arylene group, more particularly a C₁-C₁₀ and especially C₁-C₄ alkylene, in particular propylene);
the symbols Z, which may be identical or different, correspond to one of the three formulae below:

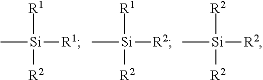

in which:
the radicals R¹, which may be substituted or unsubstituted, and identical or different, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the radicals R², which may be substituted or unsubstituted, and identical or different, represent a C₁-C₁₈ alkoxy or C₅-C₁₈ cycloalkoxy group (preferably a group chosen from C₁-C₈ alkoxy and C₅-C₈ cycloalkoxy, more preferentially still a group chosen from C₁-C₄ alkoxy, in particular methoxy and ethoxy).

In the case of a mixture of alkoxysilane polysulfides corresponding to formula (I) above, especially common commercially available mixtures, the mean value of “x” is a fractional number preferably between 2 and 5 and more preferentially close to 4. However, the invention may also advantageously be performed, for example, with alkoxysilane disulfides (x=2).

Examples of polysulfide silanes that will be mentioned more particularly include polysulfides (especially disulfides, trisulfides or tetrasulfides) of bis(alkoxy(C₁-C₄)alkyl(C₁-C₄)silyl(C₁-C₄))alkyl, for instance bis(3-trimethoxysilylpropyl) or bis(3-triethoxysilylpropyl)polysulfides. Among these compounds, use is made in particular of bis(3-triethoxysilylpropyl)tetrasulfide, abbreviated as TESPT, of formula [(C₂H₅O)₃Si(CH₂)₃S₂]₂ or bis(triethoxysilylpropyl)disulfide, abbreviated as TESPD, of formula [(C₂H₅O)₃Si(CH₂)₃S]₂. Mention will also be made, as preferential examples, of polysulfides (especially disulfides, trisulfides or tetrasulfides) of bis((C₁-C₄)monoalkoxy(C₁-C₄)dialkylsilylpropyl), more preferentially bis-(monoethoxydimethylsilylpropyl)tetrasulfide as described in patent application WO 02/083 782 mentioned previously (or U.S. Pat. No. 7,217,751).

As examples of coupling agents other than an alkoxysilane polysulfide, mention will be made especially of difunctional POS (polyorganosiloxanes) or hydroxysilane polysulfides (R²═OH in formula I above) as described, for example, in patent applications WO 02/30939 (or U.S. Pat. No. 6,774,255), WO 02/31041 (or US 2004/051 210) and WO 2007/061 550, or silanes or POSs bearing azodicarbonyl functional groups, as described, for example, in patent applications WO 2006/125 532, WO 2006/125 533 and WO 2006/125 534.

As examples of other silane sulfides, examples that will be mentioned include silanes bearing at least one thiol function (—SH) (known as mercaptosilanes) and/or at least one blocked thiol function, as described, for example, in patents or patent applications U.S. Pat. No. 6,849,754, WO 99/09036, WO 2006/023 815, WO 2007/098 080.

Needless to say, mixtures of the coupling agents mentioned previously may also be used, as described especially in the abovementioned patent application WO 2006/125 534.

In the rubber compositions of the invention, when they are reinforced with an inorganic filler such as silica, the content of coupling agent is preferentially between and 15 phr and more preferentially between 3 and 12 phr.

A person skilled in the art will understand that, as a filler equivalent to the reinforcing inorganic filler described in the present paragraph, a reinforcing filler of another nature may be used, especially of organic nature such as carbon black, as long as this reinforcing filler is covered with an inorganic layer such as silica, or comprises on its surface functional sites, especially hydroxyls, necessitating the use of a coupling agent to establish the bond between the filler and the elastomer. By way of example, mention may be made, for example, of carbon blacks for tyres as described, for example, in patents WO 96/37547 and WO 99/28380.

### C) Platy Filler

Another essential characteristic of the coating rubber is that it comprises between 10 and 150 phr of a platy filler.

Below the indicated minimum, the targeted technical effect is insufficient, whereas above the recommended maximum, insurmountable problems of increase in the modulus, of embrittlement of the composition and also filler dispersion and processability difficulties are encountered, not to mention a significant degradation of the hysteresis. For all these reasons indicated above, the content of platy filler is preferably between 20 and 100 phr, more preferably still in a range from 25 to 80 phr.

Moreover, for optimum performance, expressed this time by volume and no longer by weight, the content of platy filler is preferably less than 30%, more preferably less than 25%, in particular less than 20% (% by volume of elastomer composition or coating rubber).

Fillers referred to as platy fillers are well known to those skilled in the art. They have especially been used in tyre outer casings for reducing the permeability of conventional gastight layers (“inner liners”) based on butyl rubber. In these layers based on butyl rubber, they are generally used at relatively low levels, which do not usually exceed 10 to 25 phr (see, for example, patent documents US 2004/0 194 863, WO 2006/047 509).

They are generally in the form of stacked plates, platelets, sheets or foils with a relatively pronounced anisometry of these particles. Their aspect ratio (F=L/E) is generally greater than 2, more often greater than 3 or than 5. L represents the median length (or larger dimension) and E the median thickness of these platy fillers, these averages being calculated by number. Preferably, this aspect ratio is between 2 and 200, especially between 3 and 150, more preferably still in a range from 5 to 100, in particular from 5 to 50.

These platy fillers are preferably of micrometer size, that is to say that they are in the form of microparticles, the size or median length (L) of which is greater than 1 μm, typically between a few μm (for example 5 or 10 μm) and a few hundred μm (for example 500 or even 800 μm). According to one preferred embodiment, the median length (L) of the particles is between 5 and 500 μm, more preferably between 50 and 250 μm. According to another preferred embodiment, the median thickness (E) of the particles is itself between 0.5 and 50 μm, especially between 2 and 30 μm.

Preferentially, the platy fillers used in accordance with the invention are chosen from the group composed of graphites, phyllosilicates and mixtures of such fillers. Among the phyllosilicates, mention will especially be made of clays, talcs, micas and kaolins, these phyllosilicates possibly being modified or not, for example by a surface treatment; as examples of such modified phyllosilicates, mention may especially be made of micas covered with titanium oxide, and clays modified with surfactants (“organoclays”).

Use is preferably made of platy fillers with a low surface energy, that is to say that are relatively apolar, such as those chosen from the group composed of graphites, talcs, micas and mixtures of such fillers, the latter possibly being modified or not, more preferably still from the group composed of graphites, talcs and mixtures of such fillers. Among the graphites use may be made of natural graphites and synthetic graphites.

As examples of micas, mention may be made of the micas sold by CMMP (Mica-MU®, Mica-Soft®, Briomica® for example), vermiculites (especially the Shawatec® vermiculite sold by CMMP or the Microlite® vermiculite sold by W.R. Grace), modified or treated micas (for example, the Iriodin® range sold by Merck). As examples of graphites, mention may be made of the graphites sold by Timcal (Timrex® range). As examples of talcs, mention may be made of the talcs sold by Luzenac. As examples of glass flakes, mention may be made of the RCF600 products sold by the company Nippon Glass Sheet.

The introduction of platy fillers into the elastomer composition may be carried out according to various known processes, for example by compounding in solution, by bulk compounding in an internal mixer, or else by compounding via extrusion.

For the particle size analysis and the calculation of the median size of the (micro)particles of platy filler, various known methods can be applied, for example via laser scattering (see, for example, ISO-8130-13 standard or JIS K5600-9-3 standard).

It is also possible to use, simply and preferentially, a particle size analysis via mechanical screening; the operation consists in screening a defined amount of sample (for example, 200 g) on a vibrating table for 30 minutes with different mesh diameters (for example, according to an increasing ratio, with meshes (in μm) of 75, 105, 150, 180, etc.); the oversize material collected on each screen is weighed on a precision balance; the % of oversize material for each mesh diameter relative to the total weight of product is deduced therefrom; the median size (or median diameter) is finally calculated in a known manner from the histogram of the particle size distribution.

### D) Crosslinking System

The crosslinking system is preferentially a vulcanizing system, i.e., a system based on sulfur (or a sulfur-donating agent) and a primary vulcanization accelerator. Various known secondary vulcanization accelerators or activators such as zinc oxide, stearic acid or equivalent compounds, and guanidine derivatives (in particular diphenylguanidine), are also added to this vulcanizing system, incorporated during the first non-productive phase and/or during the productive phase as described hereinbelow.

The sulfur is used in a preferential content of between 0.5 and 12 phr, in particular between 1 and 10 phr. The primary vulcanization accelerator is used in a preferential content of between 0.5 and 10 phr and more preferentially between 0.5 and 5.0 phr.

Any compound that is capable of acting as a vulcanization accelerator for diene elastomers in the presence of sulfur may be used as accelerator, especially accelerators of the thiazole type and derivatives thereof, and accelerators of thiuram or zinc dithiocarbamate type. These primary accelerators are more preferentially chosen from the group consisting of 2-mercaptobenzothiazyl disulfide (abbreviated as MBTS), N-cyclohexyl-2-benzothiazyl sulfenamide (abbreviated as CBS), N,N-dicyclohexyl-2-benzothiazyl sulfenamide (abbreviated as DCBS), N-tert-butyl-2-benzothiazyl sulfenamide (abbreviated as TBBS), N-tert-butyl-2-benzothiazyl sulfenimide (abbreviated as TBSI), and mixtures of these compounds.

### E) Various Additives

The rubber composition constituting the coating rubber may also comprise all or some of the usual additives usually used in rubber compositions for tyres, for instance protective agents such as chemical ozone counteractants, antioxidants, plasticizers or extender oils, whether the latter are of aromatic or non-aromatic nature, especially very sparingly aromatic or non-aromatic oils, for example of the naphthenic or paraffinic type, of high or, preferably, low viscosity, MES or TDAE oils, high-Tg hydrocarbon-based plasticizing resins, processability agents for the compositions in the raw state, tackifying resins, reinforcing resins (such as resorcinol or bismaleimide), methylene acceptors or donors, for instance hexamethylenetetramine or hexamethoxymethyl-melamine, and known adhesion-promoting systems of the metallic salt type, for example salts (e.g., acetylacetonates, abietates, naphthenates, talates) of cobalt or nickel or of a lanthanide such as neodymium.

In particular, it turns out that hydrocarbon-based plasticizing resins with a high Tg, preferably greater than 20° C. and more preferentially greater than 30° C. (according to ASTM D3418-1999), may advantageously be used since they may make it possible to further improve the “water barrier” technical effect afforded by the protective elastomeric sublayer described previously.

The hydrocarbon-based resins (it is recalled that the term “resin” is reserved by definition for a compound that is solid at 23° C.) are polymers that are well known to those skilled in the art, which may be used in particular as plasticizers or tackifying agents in polymer matrices. They have been described, for example, in the book entitled “Hydrocarbon Resins” by R. Mildenberg, M. Zander and G. Collin (New York, VCH, 1997, ISBN 3-527-28617-9), chapter 5 of which is devoted to their applications, especially in tyre rubbers (5.5. “Rubber Tires and Mechanical Goods”). They may be aliphatic, aromatic, of the aliphatic/aromatic type, i.e., based on aliphatic and/or aromatic, hydrogenated or non-hydrogenated monomers. They may be natural or synthetic, optionally based on petroleum (if such is the case, they are also known under the name “petroleum resins”). They are preferentially exclusively hydrocarbon-based, i.e., they comprise only carbon and hydrogen atoms.

Preferably, their number-average molecular mass (Mn) is between 400 and 2000 g/mol and especially between 500 and 1500 g/mol; their polydispersity index (Ip) is preferentially less than 3 and especially less than 2 (reminder: Ip=Mw/Mn with Mw being the weight-average molecular mass). The macrostructure (Mw, Mn and Ip) of the hydrocarbon-based resin is determined by steric exclusion chromatography (SEC): tetrahydrofuran solvent; temperature 35° C.; concentration 1 g/l; flow rate 1 ml/min; solution filtered through a filter of porosity 0.45 μm before injection; Moore calibration with polystyrene standards; set of 3 Waters columns in series (Styragel HR4E, HR1 and HR0.5); detection by differential refractometry (Waters 2410) and its associated exploitation software (Waters Empower).

As examples of the above hydrocarbon-based plasticizing resins, mention will be made especially of cyclopentadiene or dicyclopentadiene homopolymer or copolymer resins, terpene (e.g., α-pinene, β-pinene, dipentene or polylimonene) homopolymer or copolymer resins, C5 fraction or C9 fraction homopolymer or copolymer resins, for example C5 fraction/styrene copolymer resin or C5 fraction/C9 fraction copolymer resin.

The content of hydrocarbon-based resin is preferentially between 5 and 60 phr, especially between 5 and 50 phr and even more preferentially in a range from 10 to 40 phr.

The coating rubber may also contain coupling activators when a coupling agent is used, agents for covering the inorganic filler when an inorganic filler is used, or, more generally, processing agents that may, in a known manner, by means of improving the dispersion of the filler in the rubber matrix and lowering the viscosity of the compositions, improve their processability in the raw state; these agents are, for example, hydroxysilanes or hydrolysable silanes such as alkylalkoxysilanes, polyols, polyethers, amines, and hydroxylated or hydrolysable polyorganosiloxanes.

### F) Manufacture of the Composition

The rubber compositions forming the coating rubber are manufactured in appropriate mixers using, for example, two successive preparation phases according to a general procedure that is well known to those skilled in the art: a first phase of thermomechanical working or kneading (occasionally termed the “non-productive” phase) at high temperature, up to a maximum temperature of between 130° C. and 200° C. and preferably between 145° C. and 185° C., followed by a second phase of mechanical work (occasionally termed the “productive” phase) at lower temperature, typically less than 120° C., for example between 60° C. and 100° C., during which finishing phase the crosslinking or vulcanizing system is incorporated.

A process that may be used for the manufacture of such rubber compositions comprises, for example and preferably, the following steps:
incorporating the reinforcing filler and between 10 and 150 phr of the platy filler with the diene elastomer in a mixer, and thermomechanically kneading the whole, one or more times, until a maximum temperature of between 130° C. and 200° C. is reached;
cooling the whole to a temperature below 100° C.;
next, incorporating a crosslinking system;
kneading the whole up to a maximum temperature of less than 120° C.;
extruding or calendering the rubber composition thus obtained.

By way of example, the first phase (non-productive) is performed in a single thermomechanical step during which all the necessary constituents, the optional covering agents or additional processing agents and other various additives, with the exception of the crosslinking system, are introduced into an appropriate mixer such as a common internal mixer. After cooling the mixture thus obtained in the course of the first non-productive phase, the crosslinking system is then incorporated at low temperature, generally in an external mixer such as a roll mixer; the whole is then mixed (productive phase) for a few minutes, for example between 5 and 15 minutes.

The final composition thus obtained is then calendered, for example in the form of a sheet or a plate, especially for characterization in the laboratory, or alternatively extruded in the form of a rubber profiled element which may be used directly as coating (or calendering) rubber for one or more textile or metallic reinforcing threads, as described previously.

The vulcanization (or curing) is conducted in a known manner at a temperature generally of between 130° C. and 200° C., for a sufficient time that may range, for example, between 5 and 90 minutes as a function especially of the curing temperature, of the vulcanization system adopted and of the vulcanization kinetics of the composition under consideration.

The minimum thickness (noted Em in FIGS. 1 and 2 commented below) of the coating rubber surrounding the reinforcing thread(s) is typically between 0.1 and 2 mm, especially in a range from 0.2 to 1.5 mm.

Preferably, the coating rubber has, in the vulcanized state (i.e., after curing), a secant modulus in extension E10 which is less than 30 MPa, more preferentially between 2 and 25 MPa and in particular between 5 and 20 MPa. The “secant modulus in extension” (denoted E10) is the tensile modulus measured in second elongation (i.e., after an accommodation cycle) at 10% elongation (according to ASTM D412 1998; specimen “C”), this modulus being the “true” secant modulus, i.e., reduced to the real cross section of the specimen (normal temperature and hygrometry conditions according to standard ASTM D1349-1999).

### 5. EXAMPLES OF IMPLEMENTATION OF THE INVENTION

### 5.1—Examples of Thread-Based Reinforcements in Accordance with the Invention

The attached FIG. 1 very schematically shows (without being to any specific scale), in cross section, a first example of a composite thread-based reinforcement in accordance with the invention. This composite reinforcement noted R-1 consists of a reinforcing thread (10) consisting of a single filament or monofilament of relatively high diameter (for example between 0.10 and 0.50 mm), for example made of carbon steel, polyester, Nylon® or aramid, which is covered with a layer (11) of coating rubber based on natural rubber, carbon black as reinforcing filler, graphite as platy filler and a vulcanizing system; its minimum thickness is noted Eₘ in FIG. 1.

FIG. 2 shows schematically in cross section a second example of a composite thread-based reinforcement in accordance with the invention. This composite reinforcement noted R-2 consists of a reinforcing thread (20) consisting, for example, of two monofilaments (20a, 20b) made of carbon steel cabled together, or alternatively of two multifilament textile fibres (20a, 20b) twisted together, for example made of polyester, Nylon® or aramid; the reinforcing thread (20) is covered with a layer (21) of coating rubber based on natural rubber and an SBR copolymer whose Tg is between −30° C. and +30° C., carbon black and silica as reinforcing filler, talc as platy filler and a vulcanizing system; its minimum thickness is noted Eₘ in FIG. 2.

FIG. 3 shows schematically, still in cross section, another example of a thread-based reinforcement according to the invention. This reinforcement R-3 comprises a reinforcing thread (30) consisting here of a steel construction cord 1+6, with a central thread or core thread (31a) and six filaments (31b) of the same diameter wound together helically around the central thread. This reinforcing thread or cord (30) is covered with a layer (32) of coating rubber based on natural rubber, silica as reinforcing filler, mica as platy filler and a vulcanizing system.

The examples of composite thread-based reinforcements in accordance with the invention of these FIGS. 1 to 3 may be prepared in a manner that is known per se, for example by passing the reinforcing thread through a die of suitable diameter, in an extrusion head heated to an appropriate temperature, which delivers the necessary amount of coating rubber.

FIG. 4 shows schematically in cross section another example in accordance with the invention, this time in the form of a band of reinforced rubber, in which a group of several reinforcing threads (in this case three threads for simplicity) are collectively buried in a coating rubber provided in a known manner, for example via a calendering operation. This composite reinforcement noted R-4 consists of three reinforcing threads (40) each consisting of multifilament textile plies (40a, 40b) twisted together, for example made of Nylon®, polyester or aramid, or alternatively metallic cords (40) each consisting of two monofilaments made of carbon steel (40a, 40b); the whole consisting of the three aligned reinforcing threads (40) is buried in a layer (41) of coating rubber based on natural rubber and of an SBR copolymer whose Tg is between −30° C. and +30° C., carbon black as reinforcing filler, graphite as platy filler and a vulcanizing system.

### 5.2—Use of the Thread-Based Reinforcement in Tyres

The composite thread-based reinforcement of the invention described previously may be used notably for the manufacture of any finished article or semi-finished product made of rubber, in particular for reinforcing tyre outer casings for all types of vehicles, in particular passenger vehicles or industrial vehicles such as heavy-goods vehicles.

As already indicated previously, this thread-based reinforcement of the invention may be in various forms, in a unit form (with only one reinforcing thread) or in the form of a ply, strip, band or block of rubber into which are incorporated, for example by calendering, several textile and/or metallic reinforcing threads. The final adhesion between the metal or the textile and the coating rubber may be obtained after curing, preferably under pressure, of the finished article for which the thread-based reinforcement of the invention is intended.

By way of example, the attached FIG. 5 shows very schematically a radial section of a tyre 1 with radial carcass reinforcement in accordance with the invention, intended, for example, for a heavy-goods vehicle or a passenger vehicle in this general representation.

This tyre 1 comprises a crown 2, two sidewalls 3, two beads 4, a carcass reinforcement 7 extending from one bead to the other. The crown 2, on which is mounted a tread (not shown in this schematic figure, for simplicity), is, in a manner known per se, reinforced with a crown reinforcement 6 consisting, for example, of at least two superposed crossed crown plies (known as the “working” crown plies), covered, for example, with at least one protective ply or a zero-degree hooping crown ply. The carcass reinforcement 7 is wound around the two bead wires 5 in each bead 4, the turn-up 8 of this reinforcement 7 being arranged, for example, towards the outside of the tyre 1, which is shown here mounted on its rim 9. The carcass reinforcement 7 consists of at least one ply reinforced with “radial” cords, i.e., these cords are arranged virtually parallel to each other and extend from one bead to the other so as to form an angle of between 80° and 90° with the median circumferential plane (plane perpendicular to the axis of rotation of the tyre, which is located halfway between the two beads 4 and passes through the middle of the crown reinforcement 6). Needless to say, this tyre 1 also comprises, in a known manner, a layer of rubber or elastomer 10, commonly known as the leakproofing rubber or innerliner, which defines the radially inner face of the tyre and which is intended to protect the carcass ply from the diffusion of air coming from the inner space of the tyre.

The tyre in accordance with the invention has the essential characteristic of comprising in its structure at least one composite thread-based reinforcement in accordance with the invention. This thread-based reinforcement may form, for example, all or part of the carcass reinforcement 7, of the reinforcement 5 (bead wire) of the bead area, or, according to a particularly preferential embodiment, of the crown reinforcement 6, whether as a hooping crown ply, a protective crown ply or a working crown ply. According to one particularly preferential embodiment, the thread-based reinforcement constitutes, in the belt of the tyre of the invention, a hooping ply (in particular comprising textile cords) or a protective ply (comprising metallic or textile cords), arranged circumferentially between the tread and the two working plies, the coating rubber of which, by virtue of its water-barrier properties, efficiently protects against the corrosion or moisture-induced ageing of the two working crown plies (comprising in particular metallic cords) that this hooping crown ply or protective crown ply covers radially.

### 5.3—Rubber Processing Tests

For the purposes of these tests, four rubber compositions (noted C-2 and C-3, on the one hand, and C-5 and C-6, on the other hand) were prepared in accordance with the invention, the formulations of which are given in Table 1; the contents of the various products is expressed in phr (parts by weight per hundred parts of elastomer, consisting here either of NR alone, or of a blend of NR and SBR).

The manufacture of this composition was carried out in the following manner: the reinforcing filler (carbon black), the platy filler (comprising graphite particles) for the compositions according to the invention, the diene elastomer and also the various other ingredients, with the exception of the vulcanizing system, were successively introduced into an internal mixer, the initial vessel temperature of which was around 60° C.; the mixer was thus filled to around 70% (% by volume). Thermomechanical working (non-productive phase) was then carried out in one stage of around 2 to 4 minutes, until a maximum “dropping” temperature of 165° C. was reached. The mixture thus obtained was recovered and cooled and then sulfur and an accelerator of sulfenamide type were incorporated into an external mixer (homofinisher) at 30° C., the combined mixture being mixed (productive phase) for a few minutes. The composition thus obtained was then calendered in the form of sheets (thickness equal to 1 mm) that could be used as a coating rubber in the thread-based reinforcements of the invention.

These compositions were compared with two control compositions (noted respectively hereinbelow as C-1 and C-4) of the same formulation and prepared in an identical manner, but not containing any platy filler.

To characterize the water-barrier properties of these various compositions (C-1 to C-6), the simple test that follows was performed: a “skim” (layer with a thickness equal to about 2 mm) of a “receiver” rubber composition (hereinbelow noted C—R), with dimensions of 150 mm by 150 mm, was “sandwiched”, in a mould of appropriate dimensions, between two layers (thickness equal to about 0.7 mm) of textile/rubber composites (in accordance or not in accordance with the invention) consisting of a series (laying increment of 0.5 mm) of Nylon® textile plied yarns (two plies of 94 tex twisted together) buried in a coating rubber consisting of the “barrier” compositions to be tested (C-1 to C-6) of Table 1.

The final assembly thus moulded formed a block of rubber in the shape of a parallelepiped having dimensions of 150 mm by 150 mm and a total thickness equal to 4 mm. The composition C—R used was a known rubber composition, conventionally used as a calendering rubber for pooping crown plies in a tyre belt, based on (peptized) natural rubber and on carbon black N326 (55 phr).

After curing (vulcanization) of several rubber blocks thus prepared, for 30 minutes at 150° C. and under a pressure of 15 bar (rectangular piston of 150×150 mm), the latter were removed from the mould in order to be finally subjected to a series of heat and moisture treatments at 55° C. and under a relative humidity of 95%, for a maximum duration of 2 weeks.

After treatment, samples of the receiver compositions C—R were removed from the centre of the rubber blocks by stripping, their water content (% by weight of receiver composition) was determined by a Karl-Fischer titration and compared to the initial content before treatment (namely around 0.5%, irrespective of the barrier composition tested).

The results given in Tables 2 and 3 express the water uptake, that is to say the increase in the water content observed in the receiver composition C—R for the six barrier compositions tested, in which the receiver composition was moulded. A water uptake of +1.6% expressed, for example, for the barrier composition C-1 after a treatment of 14 days means that the amount of water (% by weight of receiver composition) present in the receiver composition C—R went from 0.5% (initial state) to 2.1% (final state) after treatment.

After such a moisture and heat treatment, it is observed that the barrier compositions C-2 and C-3, on the one hand, and C-5 and C-6, on the other hand, which may be used as coating rubber in the thread-based reinforcements of the invention, have a water-barrier property that is very markedly improved when compared with the control compositions C-1 and C-4 not containing platy filler. In particular, with the barrier compositions C-3 and C-6 comprising the highest content of platy filler, irrespective of the duration of the treatment, the increase in the amount of water (parasite) collected in the composition C—R after heat and moisture treatment is 40% to 50% lower when compared with the control compositions C-1 and C-4, respectively.

In conclusion, the coating rubber used in the composite thread-based reinforcement of the invention has markedly improved water-barrier properties, giving, for example, the belt of a tyre markedly improved protection against the risks of penetration of water through the tread.

TABLE 1

| Formulation | C-1 | C-2 | C-3 | C-4 | C-5 | C-6 |
|---|---|---|---|---|---|---|
| Natural rubber (1) | 100 | 100 | 100 | 60 | 60 | 60 |
| SBR (2) | — | — | — | 40 | 40 | 40 |
| Carbon black (3) | 70 | 70 | 70 | 70 | 70 | 70 |
| Graphite (4) | — | 30 | 60 | — | 30 | 60 |
| Antioxidant (5) | 2 | 2 | 2 | 2 | 2 | 2 |
| Zinc oxide | 7 | 7 | 7 | 2 | 2 | 2 |
| Stearic acid | 0.6 | 0.6 | 0.6 | 0.6 | 0.6 | 0.6 |
| Sulfur | 5 | 5 | 5 | 5 | 5 | 5 |
| Accelerator (6) | 0.6 | 0.6 | 0.6 | 0.6 | 0.6 | 0.6 |

(1) natural rubber (peptized);
(2) SBR solution comprising 41% of styrene units and 59% of butadiene units; with, for the butadiene part, 24% of −1,2 units, 50% of trans-1,4 units and 26% of cis-1,4 units (Tg = −28° C.);
(3) ASTM N375 grade (Cabot company);
(4) graphite particles (Timrex ® 80 × 150 mesh - Timcal company);
(5) N-1,3-dimethylbutyl-N-phenyl-para-phenylenediamine (Santoflex 6-PPD from the company Flexsys);
(6) N-dicyclohexyl-2-benzothiazole sulfenamide (Santocure TBBS from the company Flexsys).

TABLE 2

| Water uptake (weight %) | | | |
|---|---|---|---|
| of the receiver | Control | Invention | Invention |
| composition (C-R) | (barrier C-1) | (barrier C-2) | (barrier C-3) |
| After treatment for | 0.95 | 0.75 | 0.55 |
| 5 days | | | |
| After treatment for | 1.45 | 1.10 | 0.9 |
| 10 days | | | |
| After treatment for | 1.60 | 1.30 | 1.0 |
| 14 days | | | |

TABLE 3

| Water uptake (weight %) | | | |
|---|---|---|---|
| of the receiver | Control | Invention | Invention |
| composition (C-R) | (barrier C-4) | (barrier C-5) | (barrier C-6) |
| After treatment for | 1.00 | 0.75 | 0.50 |
| 5 days | | | |
| After treatment for | 1.40 | 1.10 | 0.80 |
| 10 days | | | |
| After treatment for | 1.55 | 1.30 | 0.90 |
| 14 days | | | |

1-20. (canceled)

21. A composite thread-based reinforcement coated with rubber, for reinforcing a finished rubber article, the reinforcement comprising:
one or more textile or metallic reinforcing threads; and
a coating rubber coating each of the threads,
wherein the coating rubber is formed of a rubber composition that includes:
a diene elastomer,
a reinforcing filler,
between 10 and 150 phr of a platy filler, and
a crosslinking system.

22. The reinforcement according to claim 21, wherein the diene elastomer of the coating rubber is chosen from a group that includes: natural rubbers, synthetic polyisoprenes, polybutadienes, butadiene copolymers, isoprene copolymers, and blends thereof.

23. The reinforcement according to claim 22, wherein the coating rubber includes 50 to 100 phr of a natural rubber or a synthetic polyisoprene.

24. The reinforcement according to claim 23, wherein the coating rubber includes not more than 50 phr of a butadiene copolymer based on styrene and butadiene.

25. The reinforcement according to claim 22, wherein the coating rubber includes 50 to 100 phr of a butadiene copolymer based on styrene and butadiene.

26. The reinforcement according to claim 25, wherein the coating rubber includes not more than 50 phr of a natural rubber or a synthetic polyisoprene.

27. The reinforcement according to claim 24 or 25, wherein the butadiene copolymer based on styrene and butadiene is chosen from a group that includes: styrene-butadiene copolymers, styrene-butadiene-isoprene copolymers, and blends thereof.

28. The reinforcement according to claim 24 or 25, wherein the butadiene copolymer is a styrene-butadiene copolymer with a glass transition temperature of greater than −40° C.

29. The reinforcement according to claim 24 or 25, wherein the butadiene copolymer based on styrene and butadiene has a glass transition temperature of greater than −30° C.

30. The reinforcement according to claim 24 or 25, wherein the glass transition temperature of the butadiene copolymer based on styrene and butadiene is between −30° C. and +30° C.

31. The reinforcement according to claim 21, wherein a content of the reinforcing filler in the coating rubber is greater than 20 phr.

32. The reinforcement according to claim 21, wherein a content of the reinforcing filler in the coating rubber is between 20 and 100 phr.

33. The reinforcement according to claim 21, wherein a content of reinforcing filler in the coating rubber is within a range from 30 to 90 phr.

34. The reinforcement according to claim 21, wherein the reinforcing filler of the coating rubber includes silica, or carbon black, or a mixture of silica and carbon black.

35. The reinforcement according to claim 21, wherein a content of the platy filler in the coating rubber is between 20 and 100 phr.

36. The reinforcement according to claim 21, wherein a content of the platy filler in the coating rubber is within a range from 25 to 80 phr.

37. The reinforcement according to claim 21, wherein the platy filler of the coating rubber is chosen from a group that includes: graphites, talcs, micas, and mixtures thereof.

38. The reinforcement according to claim 21, wherein the platy filler includes graphite particles.

39. The reinforcement according to claim 21, wherein the coating rubber includes a hydrocarbon-based plasticizing resin.

40. The reinforcement according to claim 21, wherein the reinforcement is incorporated into a finished article or a semi-finished product made of rubber.

41. The reinforcement according to claim 21, wherein the reinforcement is incorporated into an outer casing of a tyre.

42. A finished or semi-finished rubber product, comprising:
a composite thread-based reinforcement coated with rubber,
wherein the reinforcement includes:
one or more textile or metallic reinforcing threads, and
a coating rubber coating each of the threads, and
wherein the coating rubber is formed of a rubber composition that includes a diene elastomer, a reinforcing filler, between 10 and 150 phr of a platy filler, and a crosslinking system.

43. A radial tyre for a motor vehicle, comprising:
a crown that includes a tread and a belt;
two inextensible beads;
two sidewalls connecting the two inextensible beads to the tread; and
a carcass reinforcement passing into the two sidewalls and anchored in the two inextensible beads by two bead wires,
wherein at least one of the belt, the two bead wires, or the carcass reinforcement includes a composite thread-based reinforcement coated with rubber,
wherein the reinforcement includes one or more textile or metallic reinforcing threads and a coating rubber coating each of the threads, and
wherein the coating rubber is formed of a rubber composition that includes a diene elastomer, a reinforcing filler, between 10 and 150 phr of a platy filler, and a crosslinking system.
